(19) United States
(12) Patent Application Publication
(10) Pub. No.: US 2006/0170262 A1
(43) Pub. Date: Aug. 3, 2006

(54) Child safety seat

(76) Inventors: Jonathan Gold, London (GB); Paul Sharp, Coventry (GB); Andrew Chatnin, Coventry (GB); Daniel Tyler, Bedfordshire (GB); Geoffrey Barley, Salisbury (GB)

Correspondence Address: BIRCH STEWART KOLASCH & BIRCH, PO BOX 747, FALLS CHURCH, VA, 22040-0747, US

(21) Appl. No.: 10/561,940

(22) PCT Filed: Jun. 23, 2004
(86) PCT No.: PCT/EP04/06775

§ 371 Date: Dec. 22, 2005

(30) Foreign Application Priority Data
Jun. 25, 2003 (GB) 0314807.9
Jul. 3, 2003 (GB) 0315571.0

(51) Int. Cl. B60N 2/28

(52) U.S. Cl. 297/256.12

(57) ABSTRACT

There is provided a child safety seat for use with a vehicle seat. The child safety seat comprises a cradle arranged for secure fitting to said vehicle seat, said cradle having a base part and an upright support part; a turntable, rotationally mounting to the base part of the cradle; and a seat shell, mounting on the turntable such that the turntable and the seat shell are rotatable in tandem relative to the cradle. The turntable also rotationally mounts to the upright support part of the cradle. There is also provided a cradle, turntable and seat shell for use in child safety seat as separate components, sub-assemblies or as a kit of parts. Seat belt tensioning means are also provided.

### TECHNICAL FIELD

The present invention relates to a child safety seat of the kind that is securable to the seat of a vehicle. In particular, the present invention relates to a child safety seat that is manoeuvrable to enable ready placement of the child in a secured seat and subsequent removal there from.

### BACKGROUND TO THE INVENTION

Child safety seats for use with vehicles are well known in the prior art. Such seats are typically designed to be mountable to the front or rear seat of a vehicle and to provide a safe and secure carriage environment for the child. At minimum, the seat enables the child to be securely fastened to the seat such that in the event of an emergency stop or vehicle accident the child remains securely in the safety seat, which itself remains securely mounted to the vehicle seat.

It is desirable that the child safety seat enables ready and convenient placement and removal of the child therein. In particular, it is advantageous if the child safety seat is mountable to the vehicle seat such that the seat shell thereof may be rotated towards an open vehicle door. In one mode of operation, the vehicle door is thus opened and the seat shell rotated by typically about 85-90° towards the vehicle door to a ‘loading configuration’ in which the seat shell faces the open door. The child is then securely stowed in the seat shell, which is then rotated back to its normal ‘travel configuration’, in which the seat shell generally faces the direction of travel of the vehicle.

It is desirable that the child safety seat is capable of providing steady and smooth rotation of the seat shell with relatively low effort, even when a child is accommodated in the seat shell. One problem that can be encountered is undesirable pitching of the seat shell relative to the base of the child safety seat. This problem is more pronounced when a child is accommodated in the seat shell, particularly if that child is agile and/or uncooperative.

Known rotatable child safety seats have a seat shell mounted to a turntable that is itself rotationally mounted to a child safety seat base. Such known child safety seats are for example, embodied in the seats described in European patent application EP 0 426 585 B1 in the name of Renolux Gat; United States patent U.S. Pat. No. 6,241,314 B1 in the name of Kevin Jon Pufall; and PCT patent application no. WO 02/08013 in the name of Renolux France Ind. Applicant has now realized that pitching of the seat shell relative to its base is likely to be problematic where only such a base-located turntable is employed as the rotational mounting. Undesirable pitching may occur during the action of rotation of the seat shell, or indeed may occur during normal motion of the vehicle.

The Applicant has now realized that a solution to the above-described problem may be provided by a child safety seat comprising a cradle arranged for secure fitting to a vehicle seat, wherein the cradle has a base part and an upright support part, and a turntable mounting for the seat shell that is mounted for rotation to both the base and the upright support part of the cradle. Thus, rotation of the seat shell is supported by a ‘secondary’ rotational mounting provided between an upright support of the cradle and the turntable part (typically, at a corresponding upright thereof, thereby providing added stability during motion, crash strength and security of rotational function.

It is particularly desirable that a child safety seat that provides for rotation of the seat shell is also configured to reversibly enable reclining movement of the seat shell from an upright seated position to one or more reclined positions, thereby enabling accommodation of the child in both ‘alert and awake’ and ‘tired and sleepy’ states.

Problems are however, encountered in providing a child safety seat that flexibly provides for both recline and rotate movement of the seat shell, and in particular that allows for rotation regardless of any reclined position thereof. The problems arise not only because the desired ‘rotate and recline’ movements potentially conflict in a mechanical sense, but also because the child safety seat must provide such flexibility of movement whilst not comprising its safety function, which requires both secure mounting to the vehicle seat and safe containment of the child. The child safety seat must be robust enough to withstand impact in the event of a collision and the daily wear and tear associated with regular use by an energetic child.

Other problems arise in providing such flexibility of ‘rotate and recline’ movement within a child safety seat design that provides simplicity of operation for the parent who faces the challenge of interacting with the seat whilst also struggling with a wriggling and occasionally, grumpy child. For ease of use, it is particularly desirable that the child safety seat provides for independent rotation and recline movement regardless of any initial reclined position thereof. Straightforward (e.g. single handed action) operation of the seat is also desirable, such that the seat can be moved to the desired position, even when holding an uncooperative child under one arm.

The Applicant has now realized that a solution to these problems may be provided by a variation of the child safety seat provided above comprising a cradle arranged for secure fitting to a vehicle seat, wherein the cradle has a base part and an upright support part and a turntable mounting for the seat shell that is mounted for rotation to both the base and the upright support part of the cradle. The variation involves providing a recline mechanism to the turntable mounting and seat shell arranged such that the seat shell may be reclined relative to the turntable (and hence to the cradle and vehicle seat), but also such that the turntable, recline mechanism and seat shell may together be rotated in supported fashion relative to the cradle.

Child safety seats are known which provide both ‘rotate and recline’ action, but which do not provide the supported rotation with recline capability of the child safety seat herein. Examples of prior art child safety seats with unsupported ‘rotate and recline’ function include United States patent U.S. Pat. No. 6,431,647 in the name of Combi Corporation; European patent application EP 0 853 018 B1 in the name of Aprica Kassai Kabushikikaisha; United Kingdom patent application GB 2,338,81 B1 in the name of Intier Automotive Seating Limited; and United States patent U.S. Pat. No. 4,762,364 in the name of Rock-A-Bye Restraint Company.

European patent application EP 1 247 688 A1 in the name of Combi Corporation describes a child safety seat with a seat shell rotatable on a turntable and having a back support, which forms part of the slider mechanism. To rotate the seat shell, however requires lifting the seat shell away from the base (i.e. performing a spacing action) to disengage the slider mechanism, and hence to disengage the seat shell form the back support. Rotation of the seat shell from its rest position is thus, unsupported. Additionally, the requirement to perform an initial ‘spacing’ step prior to rotation of the seat shell makes operation of the rotational function complex for the user.

It is an object of the present invention to provide a child safety seat that provides smooth and stable rotation of a seat shell relative to a base.

It is a further object of the present invention to provide such a child safety seat that provides both simplicity of operation for the parental user and comfort and safety for the child.

It is a further object of the present invention to provide a child safety seat that can be both rotated and reclined relative to a vehicle seat to which it is securely mountable.

### SUMMARY OF THE INVENTION

According to a first aspect of the present invention there is provided a child safety seat for use with a vehicle seat comprising

a cradle arranged for secure fitting to said vehicle seat, said cradle having a base part and an upright support part;

a turntable, rotationally mounting to said base part of said cradle; and

a seat shell, mounting to said turntable such that the turntable and said seat shell are rotatable in tandem relative to the cradle,

wherein said turntable also rotationally mounts to said upright support part of the cradle.

The invention provides a child safety seat for use with a vehicle seat. The child safety seat is designed to provide a safe and secure carriage environment for the child. In particular, the child safety seat is designed such that in the event of an emergency stop or vehicle accident the child remains safe and secure in the safety seat, which itself remains securely mounted to the vehicle seat.

The child safety seat comprises a cradle that is arranged for secure fitting to a vehicle seat. The vehicle may for example, be a car, van, lorry, bus, coach or aeroplane but is most usually a car. The vehicle seat may be either a front or rear seat and has known seat form. The cradle of the child safety seat is itself sized and shaped to marry up to, or at least to be readily receivable by, the vehicle seat. Secure fitting of the cradle to the vehicle seat is by any suitable secure fitting means, which may be provided to the vehicle seat, to the cradle or to both. Such secure fitting means may comprise any suitable belts and fastening means including buckles and snap-fit fastenings such as ISOFIX (industry standard) or LATCH (industry standard) fastenings.

In one typical usage mode the cradle is fitted to the vehicle seat and remains so fitted during the lifetime of use of the child safety seat rather than being fitted and removed regularly. However, in another typical usage mode the child safety seat is regularly moved between two or more vehicles and ease of secure fitting and removal is therefore particularly desirable. In both cases, security of fitting of the child safety seat to the vehicle seat is essential.

The cradle has a base part and an upright support part. In aspects, the base part and upright support part may be formed as separate parts arranged for use together (e.g. in fixed relationship to each other) or be formed as an integral cradle.

In one aspect, an inflatable element is provided between the vehicle seat and the base part of the child safety seat. Inflation thereof increases the tightness of relationship between the vehicle seat and child safety seat, when in use.

The cradle is arranged for receipt of the turntable, which rotationally mounts to the base part thereof. In one aspect, the base part of the cradle is provided with a furrow or basin therein (e.g. cut-away form) sized and shaped for ready receipt of the turntable.

The rotational mounting of the turntable to the cradle is by any suitable means, such as by means of a spindle mounting, such as one in which a spindle stands proud from the cradle and is received by a suitable spindle-receiving aperture or cavity of the turntable.

The child safety seat also comprises a child safety seat shell (e.g. of ‘trimmed shell’ form) that is arranged for secure placement of a child therein. Cushioning is suitably provided to the child-receiving part of the seat shell.

In one aspect, the shape and form of the seat shell is that of a conventional ‘sit up’ seat and typically comprises a seat shell base for support of the child's bottom and thighs and a seat shell back for support of the child's back. Wings are suitably provided to the seat shell base and seat shell back, the former functioning as side support for the child and the latter functioning to reduce freedom of child head/shoulder movement but principally to provide additional protective function (e.g. for the child's head) in the event of (e.g. a side impact) vehicle collision.

In another aspect, the shape and form of the seat shell is that of an infant carrier suitable for receipt of a very young infant, typically in a ‘recumbant’ position, and comprises a carrier base provided with surrounding walls for retaining the infant within the carrier.

The seat shell mounts to the turntable such that the turntable and seat shell are rotatable in tandem relative to the cradle.

In one aspect, the turntable mounting readily enables ready mounting/demounting of the seat shell from the turntable. Such functionality is more often required when the seat shell takes the form of an infant carrier.

As background, it is noted that child safety seats are generally of two types. The first type is often referred to in the industry as a ‘first stage’ (or Group 0) seat and is designed for safe carriage of a child of up to about twelve to fifteen months with a weight of less than 13 kg. The usage mode for such ‘first stage’ seats is typically that the child safety seat functions as both a safety seat and an infant carrier with the child remaining stowed therein as the seat shell is placed in and removed from the vehicle. A ‘first stage’ child safety seat must thus, be reversibly removable from the turntable and/or cradle (which remain fitted to the vehicle). The second type is often referred to in the industry as a ‘second stage’ (or Group I) seat and is designed for safe carriage of a child from about nine months to four years with a weight of from about 9 kg to 18 kg. The usage mode for such ‘second stage’ seats is typically that the child safety seat functions just as a vehicle safety seat and remains in the vehicle with the child being placed in and removed from the seat, which remains in situ in the vehicle. Thus, a second stage’ child safety seat shell need not necessarily be reversibly removable from the turntable and/or cradle.

In a particular aspect, the turntable mounting is configured such that it may interchangeably receive a seat shell in either the form of an infant carrier or a sit-up seat (i.e. both a ‘first stage’ and ‘second stage’ seat). This provides the advantage that when the infant progresses beyond the need for an infant carrier and requires a sit-up configuration the parent need not buy a whole new child safety seat, but only the new seat shell form. It is envisaged that the mounting will comprise fastening elements (e.g. clip-in type) arranged for fastening of both the ‘first stage’ and ‘second stage’ seat shells, which will typically have been provided with common fastening elements (e.g. at the underside thereof).

The rotational movement of the turntable (and the seat shell, which it carries) relative to the cradle is suitably from a first position, in which the turntable (and seat shell) is non-rotated (i.e. 0° rotation) relative to the normal sitting direction to a loading position, in which the turntable (and seat shell) is rotated (i.e. >0° rotation) to a position that enables ease of placement of a child in the seat shell. The turntable (and seat shell) may then be rotated back to the first position. The rotation may be in a clockwise or anti-clockwise sense (e.g. so that the seat shell may be rotated to either vehicle door opening). Suitably, in the loading position the seat shell is rotated such that it faces, or nearly does so, the vehicle door thereby corresponding to an 80-90° rotation relative to the normal sitting direction. In one aspect, the maximum degree of rotation corresponds to about 90° degrees of rotation relative to the normal sitting direction.

In accord with the present invention, the turntable also rotationally mounts to the upright support part of the cradle. A secondary rotational mounting is thereby formed. This secondary rotational mounting provides for enhanced stability of rotation as compared to child safety seats having only a base-mounted turntable. Such stability is particularly important where the rotational movement will be conducted with a child present in the seat shell.

Suitably, the turntable is also provided with an upright part that is sized and shaped for rotational mounting to the upright support part of the cradle.

In one aspect, rotational mounting of the turntable is by a track and rail mounting arrangement. Thus, a track is provided to either the upright part of the turntable or upright part of the cradle or both and a rail provided to said track or tracks, thereby forming a rotational mounting therebetween.

The length of track may in aspects be a single track, or it may be split into two or more separate but associated tracks. In one aspect, the track comprises two symmetrical lengths divided about a central support of the cradle. The central support allows for receipt of the vehicle shoulder belt of the vehicle seat for mounting the cradle to the vehicle seat, and a belt lock-off (e.g. clamp form) may be provided to this central support.

Suitably, the track and rail have curved forms. Suitably, the rail defines an ‘H form’ profile and the track is provided with ledges for receipt of the legs of the ‘H form’ rail.

Suitably, the bottom part of the seat shell (i.e. the seat shell base) remains in close relationship to base part of the cradle (e.g. in a generally horizontal configuration, in use) during rotation thereof. Similarly, the rear part of the seat shell (i.e. the seat back) remains in close relationship to upright part of the cradle (e.g. in a generally vertical configuration, in use) during rotation thereof.

In one aspect, rollers are provided to the rotationally relating parts of either the cradle or turntable or both such as to provide rolling engagement there between, and thereby enhancing the smoothness of rotation. The rollers may be provided, in aspects to the rotational mounting of the base of the turntable to the base part of the cradle or to the rotational mounting of the upright of the turntable to the upright part of the cradle. Suitably, the rollers are coated with or formed from a friction-reducing material (e.g. nylon) to enhance smoothness of rolling.

In one preferred aspect, the child safety seat herein independently provides for both reversible rotational movement of the child safety seat relative to the cradle and reversible reclining movement of the seat shell relative to the cradle.

Suitably, the child safety seat herein independently provides for both reversible rotational movement of the child safety seat relative to the cradle to a loading position, which enables ease of placement of a child in the seat shell and reversible reclining movement of the seat shell relative to the cradle from an initial position to one or more reclined positions.

Suitably, the rotational mounting of the turntable provides for said reversible rotational movement of the seat shell regardless of whether the seat shell is in a non-reclined or reclined position relative to the base.

Preferably, a reclining mechanism is provided to the turntable and/or the child safety seat shell and acts as a coupling therebetween. Suitably, the reclining mechanism is arranged such that when the turntable is rotated relative to the cradle, both the recline mechanism and seat shell rotate in tandem therewith (i.e. all rotate as a ‘single unit’ relative to the cradle).

The reversible reclining movement of the seat shell relative to the turntable (and therefore relative to the cradle) is from an initial, generally upright (e.g. child-sitting) position to one or more (e.g. from one to six) reclined positions. In aspects, the reclining movement is achievable by lateral movement of the seat shell relative to the turntable or by rotational movement of the seat shell relative to the turntable in a rotational plane that is generally perpendicular to the rotational plane defined by the rotation of the turntable (i.e. in a transverse plane) relative to the cradle, and more generally defined by the configuration (e.g. facing direction) of the seat shell.

It may therefore be appreciated that the reclining movement is typically a backwards-forwards movement relative to a normal sitting direction as would be defined by the configuration of the seat shell, which is generally either a ‘child faces forward to direction defined by vehicle seat’ configuration or less typically, but not inconceivably, ‘child faces backward to direction defined by vehicle seat’ configuration. The cradle remains static relative to the vehicle seat, to which it is securely fitted and the seat shell moves in recline fashion relative to cradle, turntable and vehicle seat.

The Applicant has noticed that in respect of prior art child safety seats, rotational movement of the seat shell is typically only straightforward when the child safety seat is in the non-reclined (i.e. initial) position. By contrast, the turntable-mounting of the recline mechanism herein independently provides for both reversible, supported rotational movement of the child safety seat relative to the cradle and reversible reclining movement of the seat shell relative to the cradle.

It will be appreciated that the child safety seat herein is designed for use in essentially two modes, namely a ‘travel mode’ in which the child is secured in the seat shell and a ‘loading/unloading’ mode in which the child is being placed into/removed from the seat shell. In general terms, in the ‘travel mode’ the enabling of reclining movement of the seat shell relative to the base is desirable whereas rotational movement thereof is either not desirable or entirely undesirable. Again in general terms, in the ‘loading/unloading mode’ the enabling of reclining movement of the seat shell relative to the base is either not very desirable or entirely undesirable whereas rotational movement thereof is desirable.

It will also be appreciated that whilst user (i.e. parent or guardian) control of reclining or rotational movement of the seat shell relative to the cradle is desirable as described herein, in the travel mode, particularly when the vehicle is moving it is essential that the seat shell does not uncontrollably move about. Reversible locking and/or control mechanisms are therefore typically provided to control the various movements such that movement is enabled when desired but otherwise the seat shell is locked in a particular position/configuration, which may be an intermediate position/configuration. Locking is certainly desirable during travel (i.e. when the vehicle is moving). Such locks and/or controls may therefore comprise reclining movement lock and/or control mechanisms and rotational movement lock and/or control mechanisms.

Preferably, the child safety seat is configured such that in the ‘travel mode’, the reclining mechanism is locked into either the initial position or/any reclined position and the turntable is locked into the non-rotated (i.e. 0° rotation) position.

Fitting of the cradle to the vehicle seat may be achieved by a variety of fitting means.

In one aspect, the base part of the cradle is provided with one or more (generally, two) ISOFIX (industry standard) fittings arranged for engagement with mating ISOFIX fittings provided to the vehicle seat.

In another aspect, the cradle is secured to the vehicle seat by means of the seat belt of the vehicle seat. Generally, a three-point fitting is employed with a first fitting provided to the cradle for receipt of the vehicle shoulder belt and two further fittings provided to the cradle for receipt of the vehicle lap belt.

Suitably, the fitting for receipt of the vehicle shoulder belt is located on the upright support part of the cradle, preferably at a central position. The vehicle shoulder belt fitting is generally provided with a lock-off element that locks off (e.g. clamps) the belt, and allows for ready passage of the belt in one direction only.

Suitably, the fittings for the vehicle lap belt are provided on or towards the base part of the cradle.

Suitably, a seat belt tensioning means is also provided to the cradle for tensioning a seat belt that is received thereby. Preferably, the seat belt tensioning means acts such as to alter (e.g. to vary, divert or make tortuous) the effective path of travel of the belt, thereby introducing tension.

In a first belt tensioning aspect of the present invention, the seat belt tensioning means comprises a drum provided with a slot for receipt of the vehicle seat belt (generally, the vehicle lap belt). The drum mounts fixedly on a drum spindle provided to the cradle that allows for rotation of the drum relative to the cradle.

Operation of the seat belt tensioning means Involves rotating the drum to an initial position, in which the slot may freely receive the belt (i.e. the plane defined by the slot corresponds to that defined by the belt). The drum is then rotated to a tensioning position, in which the effective path of travel of the belt is increased by the rotation of the slot (which receives the seat belt) of the drum.

The drum may also be provided with means for transferring rotational force thereto such as by an articulated system involving one or more levers or pivots.

In another seat belt tensioning aspect of the present invention, the seat belt tensioning means comprises a pair of jaws provided with contoured or toothed surfaces and hinged together by hinge element. The hinge element is also provided with a belt-shaped slot for receipt of the vehicle seat belt. In use, the belt threads through slot of the hinged element, wherein the belt is clamped at the hinge as the first part of the action. The belt then passes between the jaws. Closing the jaws creates a tortuous path (of increased distance) for the belt as it encounters the contoured jaw surfaces and therefore tensions the belt. Control over the opening of the jaws may be achieved by use of a torsion spring (not shown) at the hinge; by a sprung lever actuator; or by use of a threaded spindle that may be used to wind the two parts of the jaw together.

The seat belt tensioning aspects of the invention may be used in the context of the child safety seat and cradle described herein; or may be used in other child safety seats; or may be supplied as separate components of a seat belt tensioning system for use in any child safety seat.

It will be appreciated that all parts of the child safety seat herein may be manufactured and supplied separately and/or supplied as a kit of parts. The present invention encompasses all of these separate component parts and sub-assemblies thereof.

According to another aspect of the present invention there is provided a seat shell and turntable assembly for use with the child safety seat herein.

In particular, there is provided a child safety seat shell and turntable assembly for use with a cradle arranged for secure fitting to a vehicle seat, said cradle having a base part and an upright support part, to form a child safety seat for use in a vehicle, the assembly comprising

a turntable, rotationally mountable to said base part of said cradle; and

a seat shell, mounting to said turntable such that the turntable and said seat shell are rotatable in tandem relative to the cradle,

wherein said turntable is also rotationally mountable to said upright support part of the cradle.

According to another aspect of the present invention there is provided a cradle assembly for use with the child safety seat herein.

In particular, there is provided a cradle assembly for use with a child safety seat shell and turntable assembly as described above, the cradle assembly comprising

a cradle arranged for secure fitting to said vehicle seat, said cradle having a base part and an upright support part;

said base part of said cradle arranged for rotational mounting of a turntable,

wherein said upright support part of the cradle is also arranged for rotational mounting of said turntable.

According to another aspect of the present invention there is provided a cradle and turntable assembly for use a seat shell to form a child safety seat herein.

In particular, there is provided a cradle and turntable assembly, said cradle and turntable assembly comprising

a cradle arranged for secure fitting to said vehicle seat, said cradle having a base part and an upright support part;

a turntable, rotationally mounting to said base part of said cradle, and arranged for rotational mounting of a seat shell such that said turntable and said seat shell are rotatable in tandem relative to the cradle,

wherein said turntable also rotationally mounts to said upright support part of the cradle.

### BRIEF DESCRIPTION OF THE DRAWINGS

The invention will now be described further with reference to the accompanying drawings, in which:—

FIG. 1 shows a perspective view of a first child safety seat in accord with one aspect of the present invention;

FIG. 2 shows a perspective view of a sub-assembly minus the child safety seat shell part of the child safety seat of FIG. 1;

FIG. 3 shows a perspective, exploded view of the child safety seat of FIG. 1;

FIG. 4 shows a perspective view of a first turntable part of the sub-assembly of FIG. 2;

FIG. 5 shows a perspective view of a first cradle part of the sub-assembly of FIG. 2;

FIG. 6 shows a perspective view of a second cradle part of the sub-assembly of FIG. 2;

FIG. 7 shows a perspective view of a second child safety seat in accord with one aspect of the present invention;

FIG. 8 shows a perspective view from above of a base part of a cradle for use with the second child safety seat of FIG. 7;

FIG. 9 shows a perspective view from above of a base and upright part of a cradle for use in combination with the lower seat base part of FIG. 8 in the second child safety seat of FIG. 7;

FIG. 10 shows a perspective view of a turntable with upright part suitable for use in the second child safety seat of FIG. 7;

FIG. 11 shows a perspective view of a cradle sub-assembly unit for use in the second child safety seat of FIG. 7;

FIG. 12 shows a perspective view of a turntable sub-assembly unit for use in the second child safety seat of FIG. 7;

FIG. 13 shows a perspective view of a seat sub-assembly unit comprising the cradle sub-assembly of FIG. 11 and turntable sub-assembly of FIG. 12;

FIG. 14 shows a perspective view from the back of a seat shell for use in combination with the seat sub-assembly unit of FIG. 13;

FIG. 15a shows a perspective view of detail of a track and rail assembly for use in the seat sub-assembly of FIG. 13;

FIG. 15b shows a sectional view of a detail of a track and rail assembly for use in the seat sub-assembly of FIG. 13;

FIG. 16 shows a perspective view from above of the cradle of the second child safety seat with rotary lock mechanism features visible;

FIG. 17 shows a perspective view from the underside of the turntable part of the second child safety seat with rotary lock mechanism features visible;

FIG. 18a shows a perspective view from the side of a part-assembly of the cradle and turntable parts FIGS. 16 and 17 with ‘uni-rotary’ lock features visible;

FIG. 18b shows a detailed perspective view of the ‘uni-rotary’ lock features;

FIG. 19 shows a perspective view from above of the base part of the cradle and belt tensioning mechanism of the second child safety seat;

FIG. 20 shows a side view of a ‘hinged jaw’ seat belt tensioning mechanism herein; and

FIG. 21 shows a perspective view of a ‘car jack’ seat belt tensioning mechanism herein.

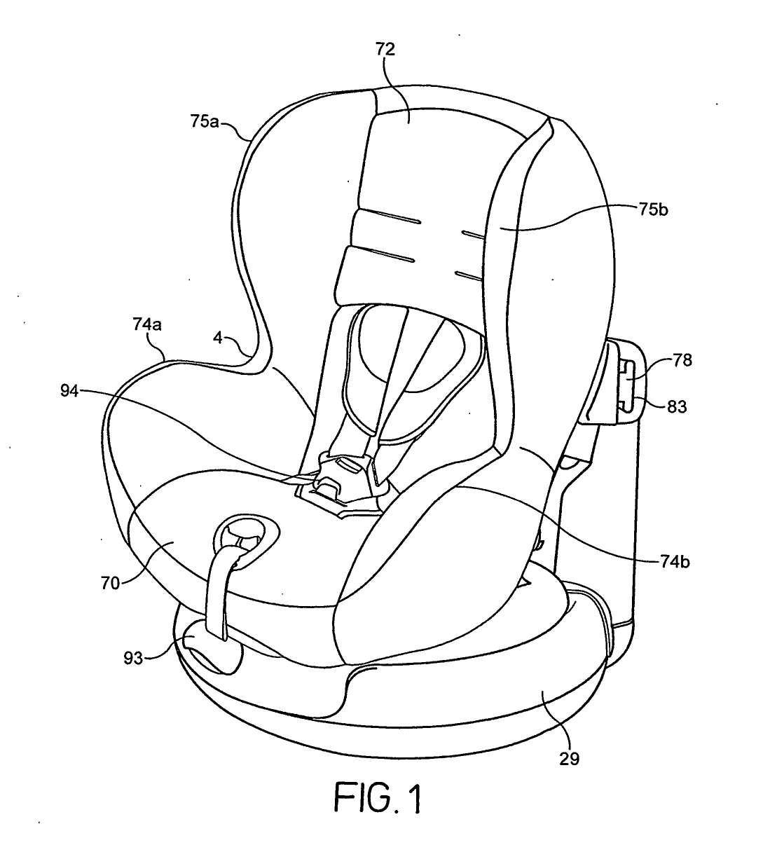

Referring now to the drawings, FIG. 1 illustrates a child safety seat herein, which provides for independent recline and rotational movement of a child safety seat shell relative to a cradle. The general arrangement of the child safety seat is as follows:

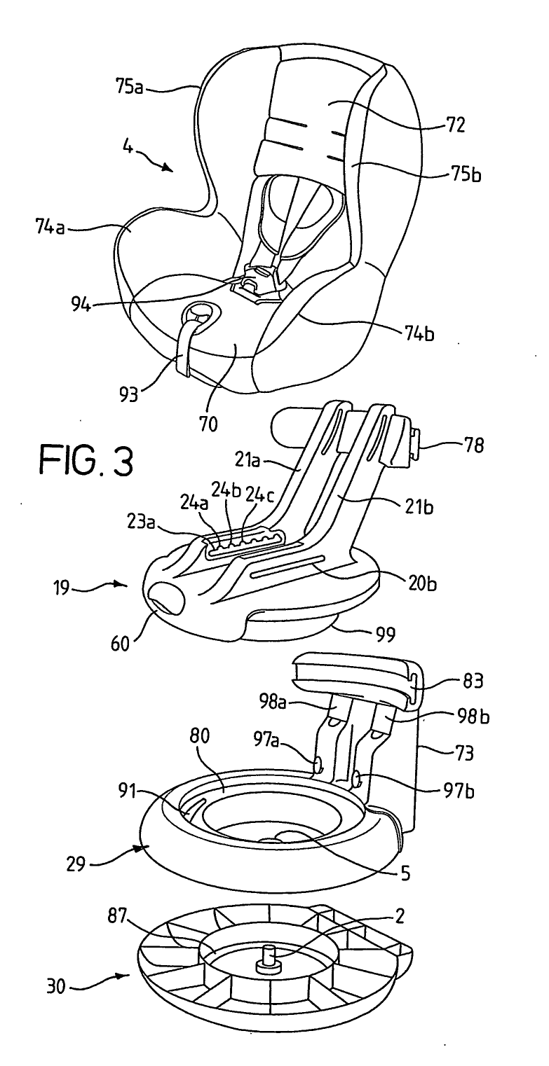

Turning first to FIGS. 1 and 3, which show the child safety seat in perspective and exploded views, the child safety seat may be seen to comprise a seat shell 4 and a cradle 29, 30. The seat shell 4 has a seat base 70 for receiving the child's bottom and thighs, a seat back 72 and lower 74a, 74b and upper 75a, 75b pairs of wings, which provide protection in the case of vehicle accident. The seat shell 4 is also provided with adjuster 93 and buckle 94 for securing a child in the seat.

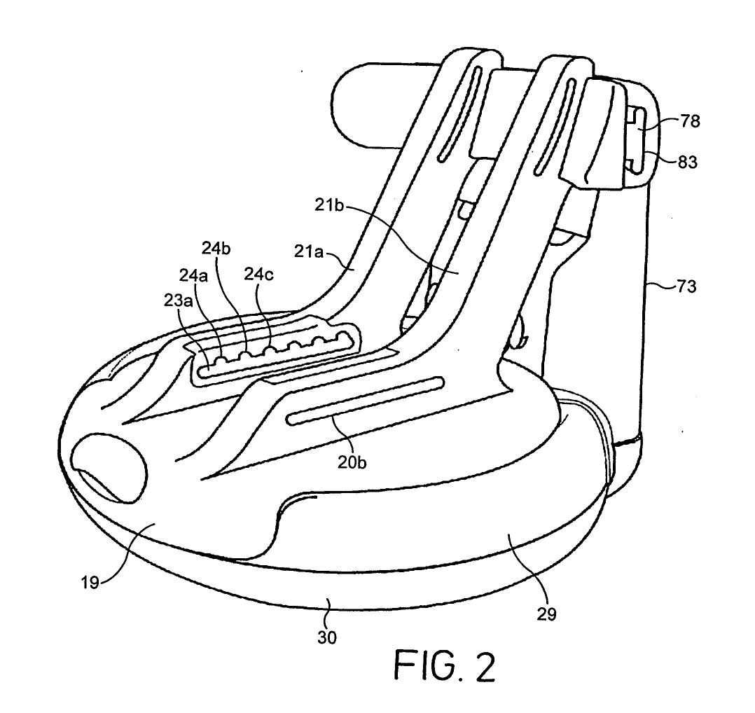

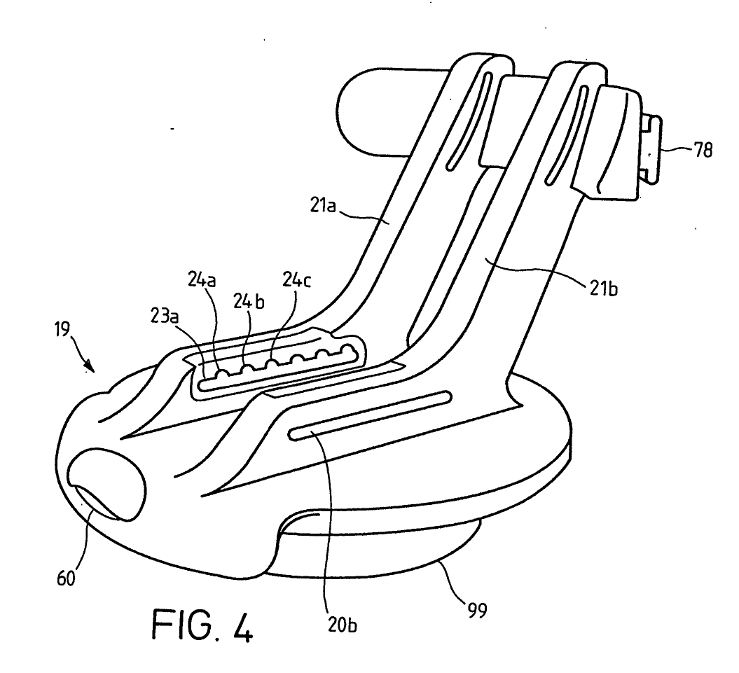

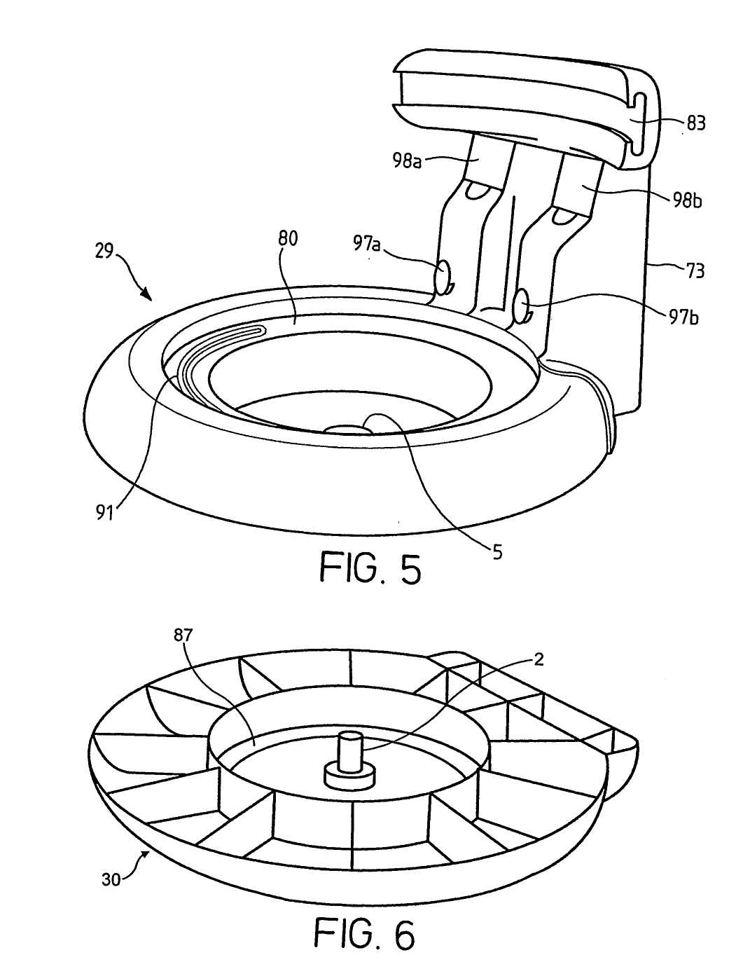

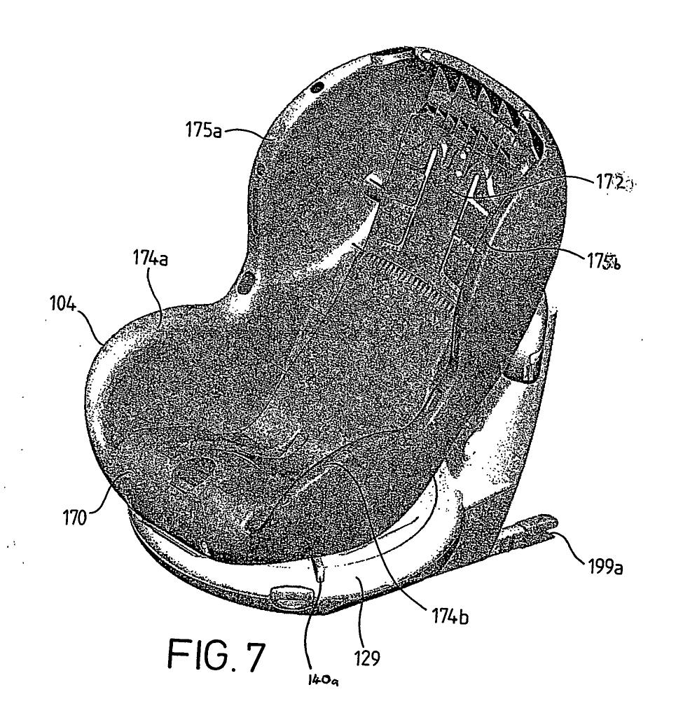

With particular reference to FIG. 3, the child safety seat may be seen to comprise four main components: seat shell 4; turntable 19; upper part of cradle 29 and base plinth 30. FIG. 2 shows a sub-assembly of the latter three components and FIGS. 4 to 6 respectively show details of the turntable 19; cradle 29 base plinth 30 in greater detail.

It will be appreciated from the description hereinafter, that the turntable 19 has three main functions: to act as a mounting for the seat shell 4; to support a recline mechanism that allows secure and steady reclining of the seat shell 4; and to act as one half of a rotating joint which allows both itself and the seat shell 4 attached to it to rotate relative to cradle 29 as a single entity about a generally vertical axis.

Seat shell 4 attaches to turntable 19 by way of a slider mechanism comprising dual sets 20a (not visible), 20b and 23a, 23b (not visible) of runners located on arms 21a, 21 b of the turntable 19. The second set of runners 23a is provided with plural notches 24a, 24b, 24c, each notch corresponding to a defined position of recline. It will be appreciated that each set of runners 20a, 20b and 23a, 23b receives pins (not visible) located on the underside of the seat shell 4 and therefore that this arrangement enables movement of the seat shell 4 relative to the turntable 19 and cradle 29 to various defined recline positions.

The turntable 19 couples permanently, but movably to cradle 29 at two main points of coupling. Firstly, central spindle 2 protrudes from base plinth 30 and feeds through hole 5 in the cradle 29 and a similar hole in turntable 19 (not visible) where a capping bolt (again not visible) is applied. The capping bolt is applied in such a way that turntable 19 is rotatable about the cradle 29 and lower base 30. Secondly, curved slide rail 78 is retainably received by curved track 83 located on the inner part of the back 73 of the cradle 29.

In use, the two points of joining maintain the turntable 19, cradle 29 and rotational plinth as a defined sub-assembly (i.e. as shown in FIG. 2). In particular, receipt of the curved slide rail 78 by the curved track 83 is arranged such that a degree of coupling is retained by this join even when the turntable 19 is rotated by up to 90° relative to the cradle 29 and base plinth 30.

Operation of the rotational mechanism as described is by use of handle 60, which is pulled outwards to release a locking pin (not visible) which protrudes from the turntable 19 into the cradle 29 and the release of which allows the recline module to rotate relative thereto. The handle 60 and locking pin are spring-loaded such that the spring (not visible) returns the handle 60 and locking pin to a rest position when the handle 60 is released. The locking pin may therefore be used to lock the turntable 19 in either the forward facing or 90° clockwise or anti-clockwise rotated positions.

As will be appreciated from the description herein, the cradle 29 has three main functions: to act as the main anchor point for the whole unit to the vehicle seat; to define the angle of the backrest part of the seat shell 4 when received in the vehicle seat to create a suitable geometry for the rotation function to operate successfully; and to act as the second half of a rotating junction providing an area for the turntable 19 and seat shell 4 to rotate upon.

In use, the base is securely fitted to a vehicle seat by use of a three-point seat belt fixing system at vehicle lap belt fixing points 97a, 97b and left or right hand vehicle shoulder belt fixing point 98a or 98b. Metal locking plate 91 for the previously described rotation locking pin (not visible) is set in to a circular recess 80 provided to the inner part of the cradle 29.

The principal function of the base plinth 30, which sits on the vehicle seat and receives the other parts of the child safety seat, is to act as a platform which defines the angle of the seat shell 4 relative to the vehicle seat to create a suitable geometry for the rotation function to operate successfully. It also provides central spindle 2, which defines the axis of rotation for the turntable 19 and seat shell 4 fixed thereto. The base plinth 30 is also provided with nylon bearing 87, which defines a track, about which the base 99 of turntable 19 can run freely. Additionally, internal webbing is present as on all mouldings to add strength.

It will be appreciated that the arrangement of the child safety seat of FIGS. 1 to 6 advantageously enables the seat shell 4 to be independently rotated and reclined. Such function is enabled without the need to introduce any step in which, a spacing movement is employed to create space between the moving parts (e.g. the seat shell 4 and cradle 29). The seat shell 4 may be readily rotated in either direction (i.e. clockwise or anticlockwise) whilst in either the fully upright or any recline position.

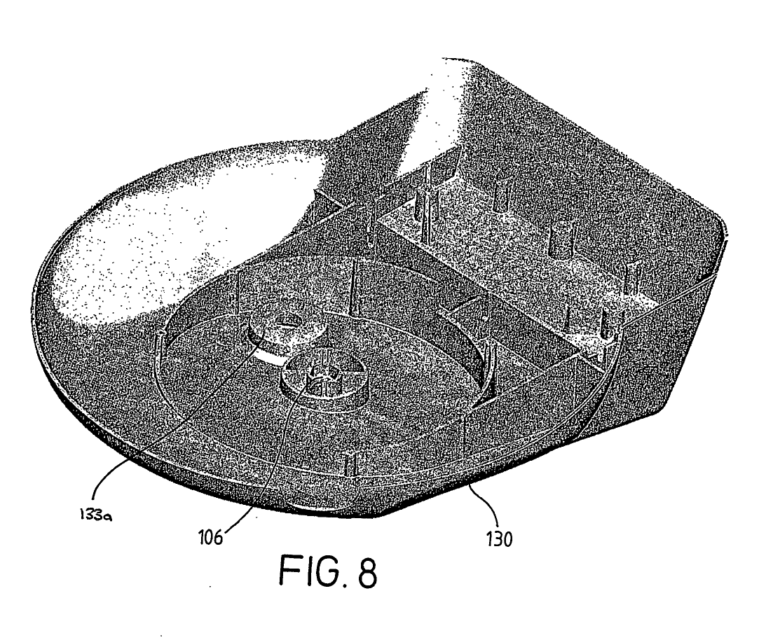

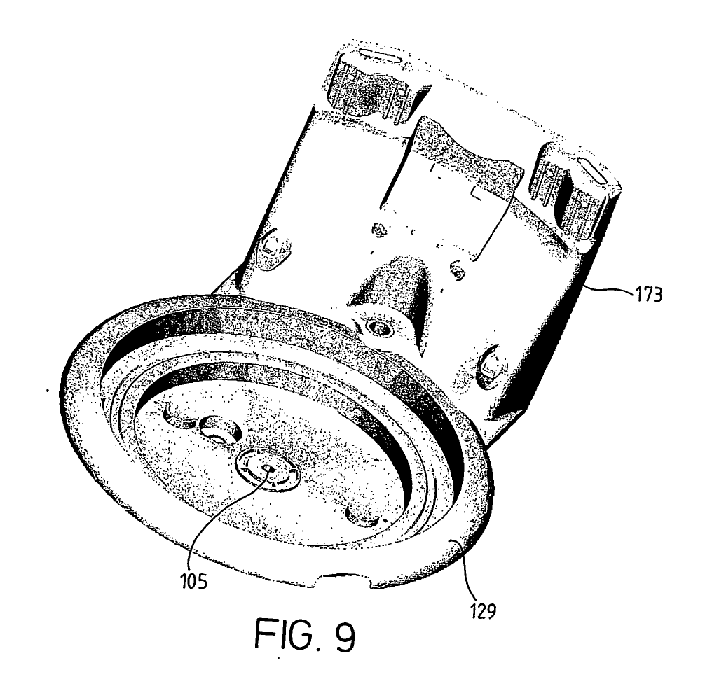

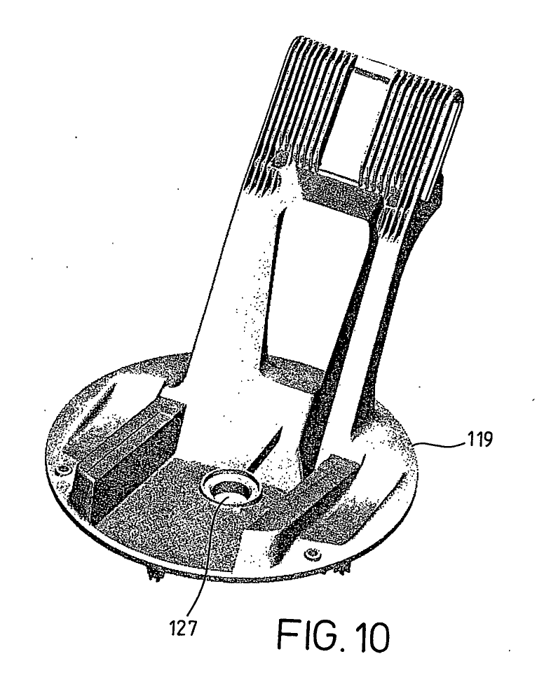

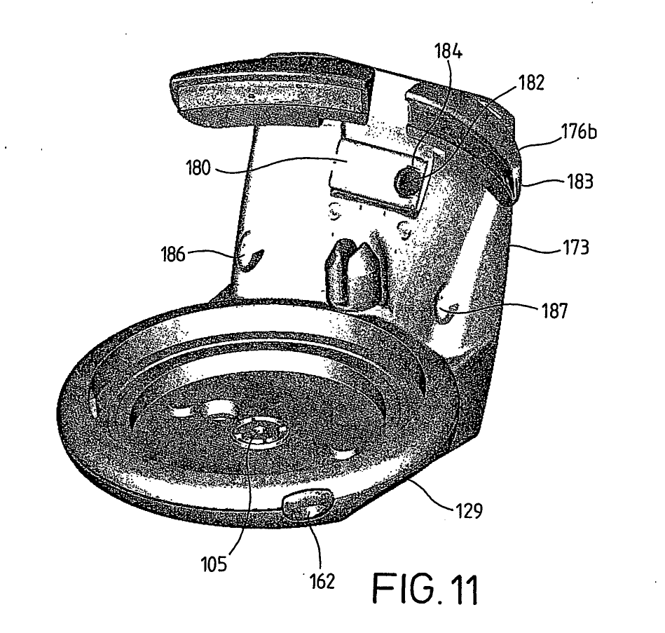

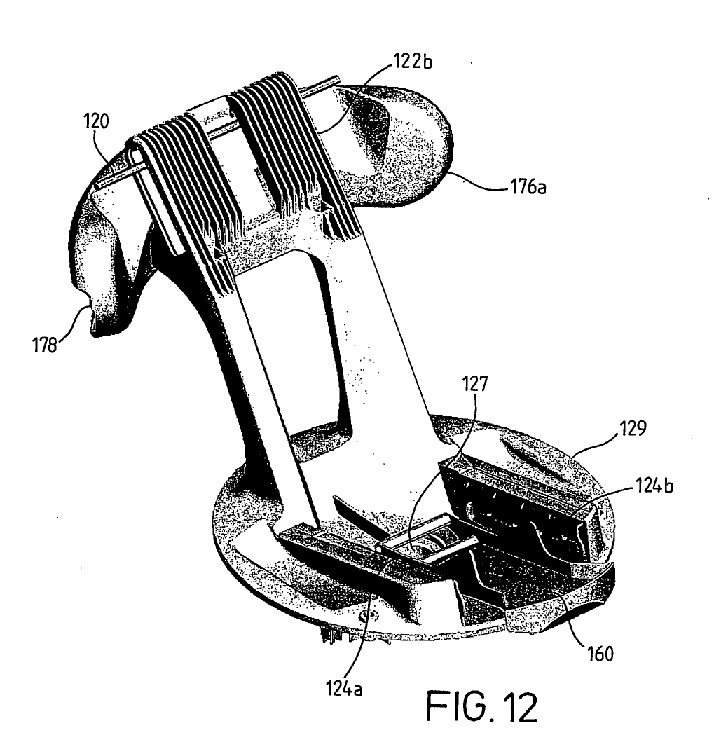

FIG. 7 illustrates a second child safety seat herein, which provides for independent recline and rotational movement of a child safety seat shell 104 relative to its cradle 129, 130. FIGS. 8-10 and 14 respectively illustrate a base part 129 of cradle; an upper part 130 of cradle; a turntable 119 part; and a seat shell 104 for use with the second child safety seat of FIG. 7. FIGS. 11-13 respectively show base sub-assembly unit; recline mounting sub-assembly unit; and seat sub-assembly unit for use in the second child safety seat of FIG. 7. The general arrangement of the child safety seat is now described.

Turning now to FIGS. 7 to 14, the child safety seat may be seen to comprise a seat shell 104 and cradle comprising upper 129 and lower 130 cradle parts. The upper 129 and lower 130 cradle parts are in fixed relationship to each other. The seat shell 104 (shown minus cushioning) has a seat base 170 for receiving the child's bottom and thighs, a seat back 172 and lower 174a, 174b and upper 175a, 175b pairs of wings, which provide protection in the case of vehicle accident. In use, the seat shell 104 would also be provided with an adjuster and buckle (e.g. as in FIG. 1) for securing a child in the seat shell 104.

The child safety seat may thus, be appreciated to comprise three principal components: seat shell 104; turntable 119; and cradle comprising upper 129 and lower parts 130, which are in fixed relationship to each other.

The turntable 119 has three main functions: to act as a mounting for the seat shell 104; to allow secure and steady reclining of the seat shell 104; and to act as a rotational mounting to the cradle 129, 130 and which allows the turntable 119 and the seat shell 104 attached to it to rotate as a single entity about a defined axis.

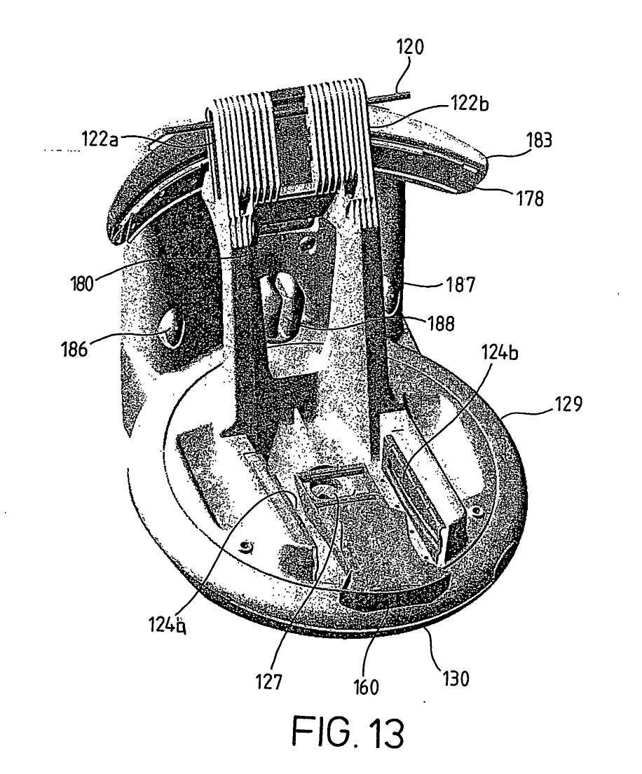

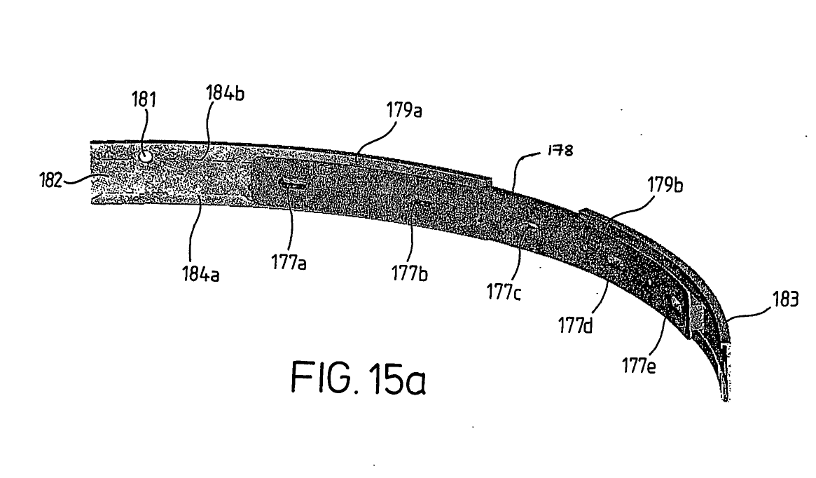

Seat shell 104 attaches to turntable 119 by way of a recline mechanism (best viewed in FIG. 12). The first part of the recline mechanism secures the back of the seat shell 104 to the back of turntable 119 and comprises back securing rod 120, the ends of which are received within back securing holes 121a, 121b of the seat shell (see FIG. 14). The securing rod 122 is itself movably retained within slots 122a, 122b that define a track about which the back of the seat shell 104 may move. The second part of the recline mechanism comprises base securing rod (not visible), which is received within base securing holes 123a, 123b such that the ends of the rod protrude for receipt by notched runners 124a, 124b provided to the base of the turntable 119. Akin to the arrangement of the recline mechanism of FIG. 2, each runner 124a, 124b has plural notches provided thereto, each notch corresponding to a defined position of recline. It will be appreciated that the above described track 122a, 122b and notched runner 124a, 124b arrangement allows for reclining movement of the seat shell 104 relative to the turntable 119 and cradle 129, 130 to various defined recline positions.

User operation of the recline mechanism is responsive to handle 160, which is lifted upwards to move the base securing rod between defined notch positions on the runners 124a, 124b, and hence from one position of recline to another.

In a key aspect, the turntable 119 and the seat shell 104, which it carries is rotated with respect to the cradle 129, 130 of the child safety seat. To achieve the desired rotation, turntable 119 is received for rotation by cradle 129, 130 by means of a spindle mounting bolt (not shown) that fits first through spindle mounting aperture 127 of the turntable 119 and then is received by central apertures 105, 106 provided respectively to the upper 129 and lower 130 cradle parts. Overall, the spindle bolt is fitted in such a way that turntable 119 and the seat shell 104, which it carries may be rotated about both parts 129, 130 of the cradle, which parts 129, 130 are in turn fixed relative to each other.

To ensure that the desired rotation may occur without compromise to the security of mounting of the seat shell 104 to the cradle 129, 130 a ‘secondary’ rotational mounting is provided. In more detail, curved track mounting is provided to inner part of the upright support 173 of the upper cradle 129. In more detail, slide rail mounting 178 housed within slide rail housing 176a located on the upright back of turntable 119 is retainably received by curved track 183 housed within curved track housing 176b located on the upright support 173 of the upper cradle 129.

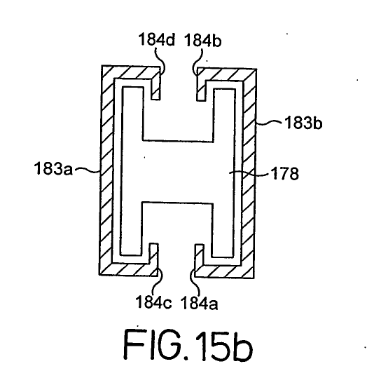

Further details of the slide rail mounting 178 and curved track mounting 183 are shown in FIGS. 15a and 15b. The curved track mounting comprises rear curved track 183b as shown in both Figures, but also front curved track 183a (only shown in FIG. 15b), which locates to the front of the ‘H form’ slide rail 178. It will be appreciated that the form of the front 183a and rear 183b curved tracks is mirrored for effective receipt of the ‘H form’ slide rail 178. Rear curved track 183b may be seen to comprise lower 184a and upper 184b ledges that define upper and lower tracks (similarly front curved track 183a comprise lower 184c and upper 184d ledges to define mirroring upper and lower tracks) that receive lower (not visible) and upper 179a, 179b sets of ‘vertically’ mounted tracking wheels provided to the slide rail 178.

The slide rail further comprises five ‘horizontally’ mounted tracking wheels 177a-e that run along the inner wall 182 of the curved track 183. End stops 181 (one only visible on rear curved track 183b) are also provided towards each end of the curved tracks 183a, 183b to prevent the slide rail 178 from travelling there beyond and becoming detached from the tracks 183a, 183b. Overall, the slide rail 178 and curved tracks 183a, 183b provides for smooth, but secure rotary motion between the upright support 173 of the upper cradle 129 and the seat shell 104.

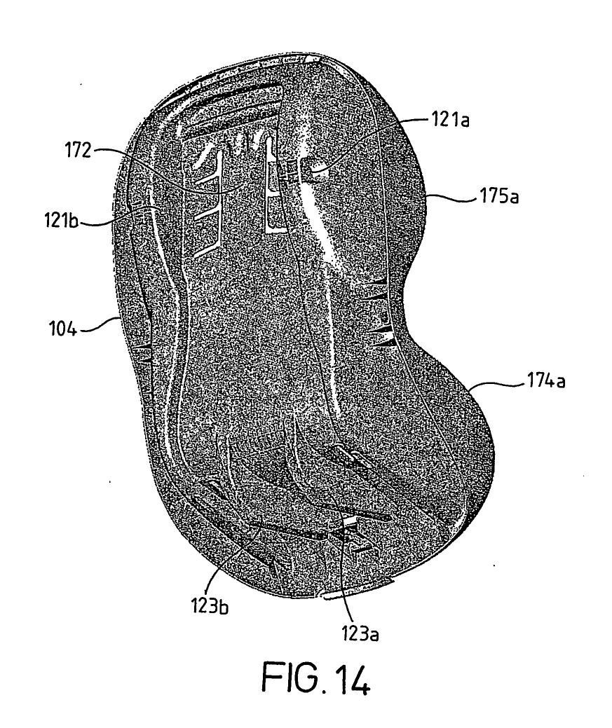

The ‘base of seat’ and ‘back of seat’ elements of the rotational mounting act in combination such as to join turntable 119 to upper 129 and lower 130 cradle parts as a defined sub-assembly (i.e. as shown in FIG. 13). Receipt of the curved slide rail 178 by the curved track mounting 183 is arranged such that a degree of coupling exists even when the turntable 119 is rotated by up to about 90° relative to the cradle 129, 130. The end stops 181 however, prevent ‘over travel’ as described above.

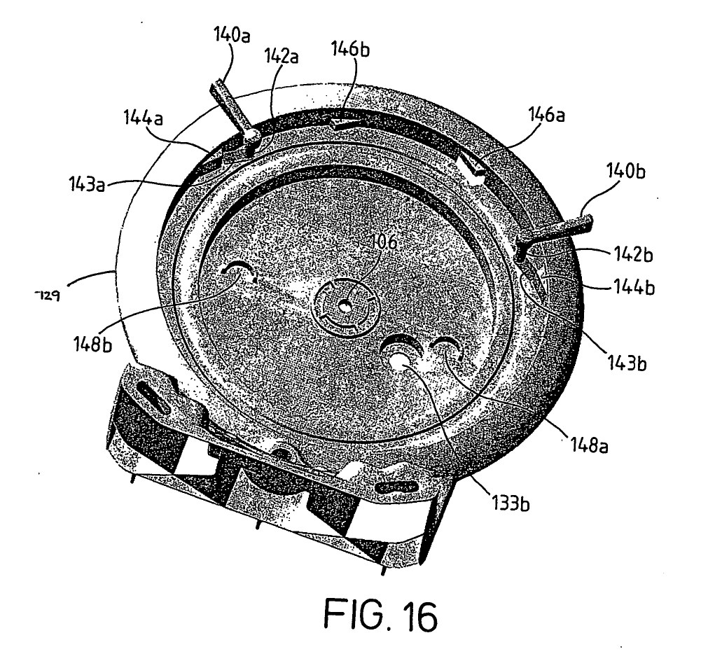

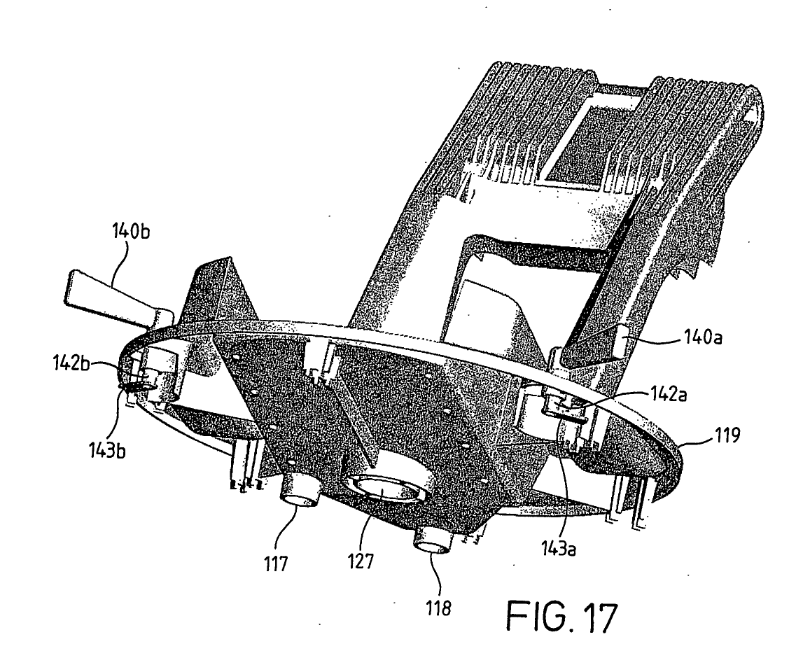

User actuation of seat shell 104 rotation is by use of either right or left hand handles 140a, 140b (as shown), the action of which may be understood by reference to FIGS. 16 and 17. As best seen in FIG. 17, which shows the turntable 119 but not the upper cradle 129, each handle 140a, 140b stands proud from turntable 119, and is pivotally mounted on respective spindle 142a, 142b. As best seen in FIG. 16, which shows the upper cradle 130 but not the turntable 119, each spindle 142a, 142b is provided at its lower end with a protruding foot 143a, 143b. In an ‘at rest’ position, each protruding foot 143a, 143b catches on its end stop 144a, 144b to prevent rotation of the turntable 119 relative to the upper cradle 129. In a subtle aspect of the design, the reason for which will become clearer in the course of the description below, first end stop 144a is located higher up (i.e. further from the base of the child safety seat) than second end stop 144b.

User actuation of the rotation of seat shell 104 is now described by reference to release of the right-hand handle 140a. The user grasps handle 140a and rotates it and therefore its spindle 142a until protruding foot 143a disengages from its stop 144a. The turntable 119 may now be rotated in an anti-clockwise direction until such point as protruding foot 143b encounters its foot stop 146b from which it is separated by an 85° degree of rotation. The protruding foot 143b does not (on the way through) engage the foot stop 146a provided for the right-hand handle 140a and protruding foot 143a because that foot stop 146a locates at a higher level relative to the upper cradle 129.

An additional feature to stop undesired rotation beyond 85° is provided by the interaction between half moon-shaped protuberances 148a, 148b provided to the upper cradle 129, as shown and peg 118 provided to the base of the turntable 119. At the position of 85° degree of anti-clockwise rotation, peg 118 engages first half-moon protuberance 148a to prevent any further rotation.

To rotate turntable 119 back to its initial position (i.e. 0° degree of rotation) the user grasps handle 140b and rotates it therefore its spindle 142b until protruding foot 143b disengages from its foot stop 146b. The turntable 119 may now be rotated in a clockwise direction until such point as protruding foot 143b re-contacts stop 144b and protruding foot 143a becomes engaged with stop 144a. Handles 140a, 140b are sprung to preferentially bias each handle 140a, 140b into the closed position.

Release of handle 140a to allow for anti-clockwise rotation is described above. It will be appreciated that release of handle 140b provides in a similar manner for rotation up to the 85° degree of rotation maximum in the opposite rotary direction.

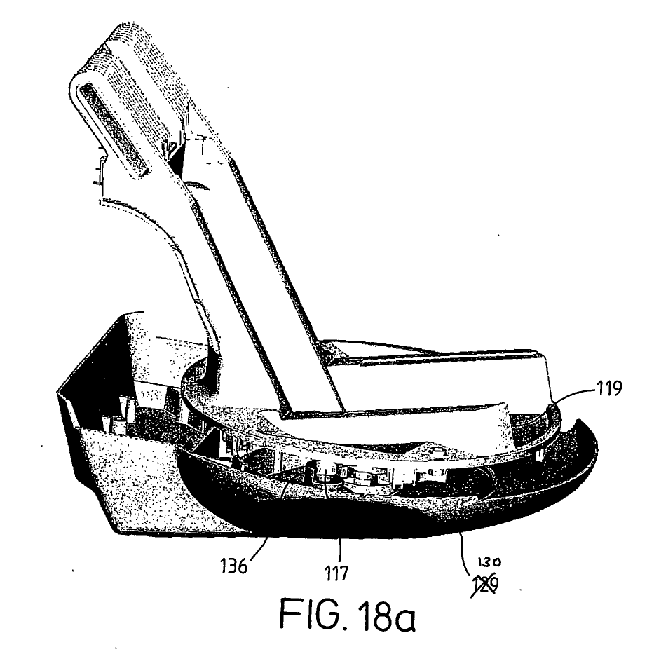

It is often desirable to configure the child safety seat to allow for rotation in only one rotary direction. For example, where the car seat is to be located by a vehicle door, rotation towards that door is useful but rotation away from the door may be undesirable. As an optional feature, the second child safety seat herein provides a ‘uni-rotational’ lock mechanism, as may be understood by reference to FIGS. 18a and 18b.

The ‘uni-rotational’ lock mechanism comprises ‘filler cap’ form plug 134 having spigot end 135 that receives half-moon shaped switch 136. The plug 134 is received through holes 133a, 133b provided to upper 129 and lower 130 cradle parts such that the plug 134 nests within hole 133a cavity provided at the underside of the cradle base 130. As is best seen in FIG. 18a, in use, the half moon switch 136 interacts with lock peg 117 provided to the underside of turntable 119. As shown in FIG. 18a, it will be appreciated that clock-wise rotation of the turntable 119 is prevented by interaction of the lock peg 117 and half moon switch 136. If however, half moon switch 136 is rotated by 180° to a second position, then rotation of the turntable 119 in the anti-clockwise direction is now prevented.

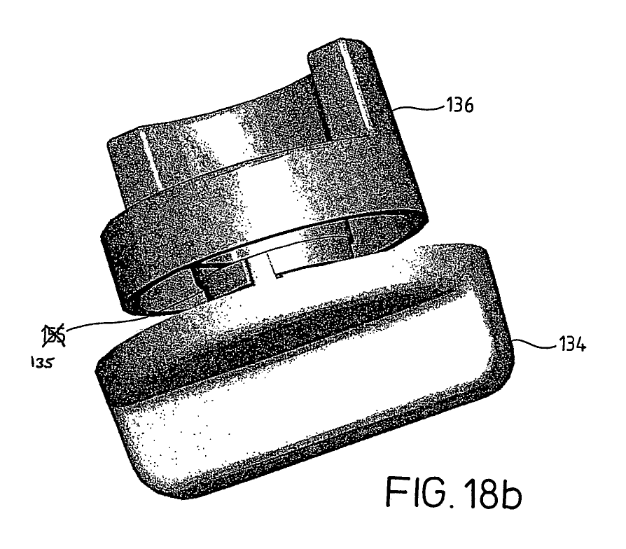

In use, cradle 129, 130 is securely fitted to a vehicle seat by use of either a two-point ISOFIX fixing system 199a (other ISOFIX fixing point, 199b not visible) or a seat belt fixing system. As best seen in FIG. 11, the seat belt fixing system involves receipt of a vehicle seat vehicle shoulder belt (not visible) at central fixing point 180, at which the belt is locked off by use of a conventional belt locking off mechanism comprising movable arm 182, which in the ‘locked-off’ position is received in clasped fashion by clasp 184. The seat belt fixing system further involves receipt of the vehicle seat vehicle lap belt (not visible) by left and right guides 186, 187 and also by rotating drum 188 tensioning mechanism, which may be better understood by reference to FIG. 19.

Referring to FIG. 19, it may be seen that drum 188 is provided with a slot 189 for receipt of the vehicle seat vehicle lap belt. The drum 188 mounts fixedly on drum spindle 164 that is rotatable in response to movement of spindle arm 165 that itself connects via intermediate arm 166 to rotary mounted control arm 167. The control arm 167 is operable by handle 162 that protrudes from the cradle 129, 130.

Operation of the drum tensioning mechanism is as follows: User grasps handle 162 and moves it in a clock-wise rotary sense thereby successively rotating control arm 167; moving intermediate arm 166 and spindle arm 165; causing rotation of drum spindle 164 and drum 188; and thereby moving the slot 189 from an initial ‘tensioning’ position where it is perpendicular to the upright support 173 of the upper cradle 129 (as shown in FIG. 19) to a position parallel with the upright support 173 of the upper cradle 129 in order to receive the belt. The handle 162 is then rotated in an anti-clockwise sense thereby moving the slot 189 of the drum 188 back to its initial ‘tensioning’ position. It will be appreciated that in the belt tensioning position, the effective path of travel of the vehicle lap belt is increased by rotation of the slot 189 (which receives the belt) of the drum 188.

It will be appreciated that the arrangement of the second child safety seat of FIGS. 7 to 14 advantageously enables the seat shell 104 to be independently rotated and reclined. Such function is enabled without the need to introduce any spacing step to create space between the rotatable parts (e.g. the seat shell 104 and cradle 129, 130). The seat shell 104 may be readily rotated in either direction (i.e. clockwise or anticlockwise) whilst in either the fully upright or any recline position.

As will be apparent from the foregoing description, it is important to have a mechanism for tensioning the vehicle seat belt in situations where the child safety seat is fixed to the vehicle seat by a vehicle belt fixing system.

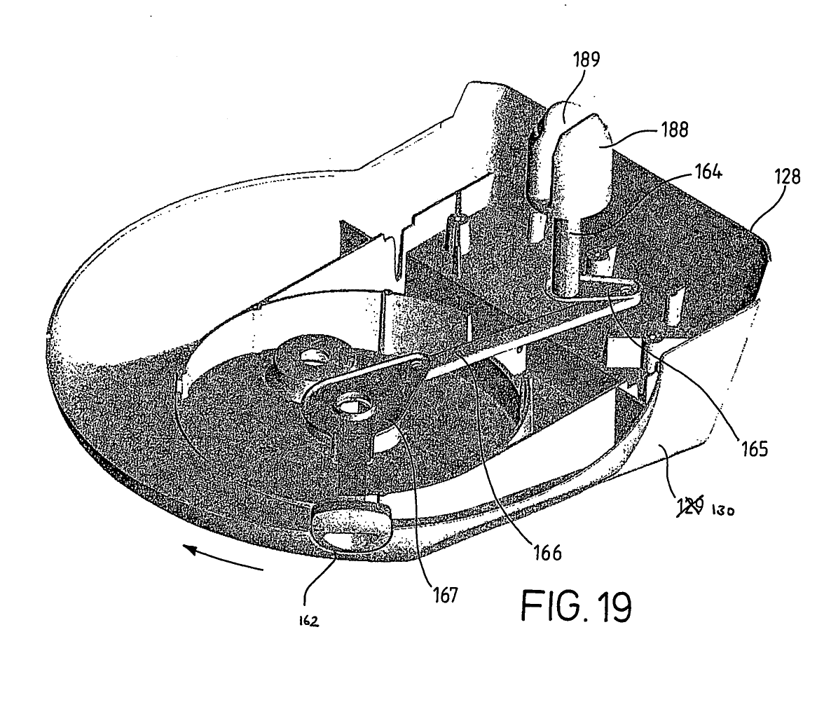

One alternative seat belt tensioning system is shown in FIG. 20. The system comprises a pair of jaws 288a 288b provided with contoured or toothed surfaces 289a, 289b and hinged together by hinge element 264. The hinge element 264 is also provided with a belt-shaped slot 265 for receipt of the vehicle seat belt. In use the belt 201 threads through slot 265 of the hinged element 264, wherein the belt 201 is clamped at the hinge 264 as the first part of the action. The belt 201 then passes between the jaws 288a, 288b. Closing the jaws 288a, 228b creates a tortuous path (of increased distance) for the belt as it encounters the contoured jaw surfaces 289a, 289b and therefore tensions the belt. Control over the opening of the jaws 288a, 288b may be achieved by use of a torsion spring (not shown) at the hinge; by a sprung lever actuator; or by use of a threaded spindle that may be used to wind the two parts 288a, 288b of the jaw together.

It may be appreciated that the nature of the contoured surfaces 289a, 289b may be varied to create pathways of greater or lesser tortuous nature depending on the degree of additional distance of travel required and tension desired at full jaw 288a, 288b closure.

The ‘hinged jaw’ mechanism of FIG. 20 may be located to introduce tension at any point in the vehicle belt, and be employed for either the shoulder or lap vehicle belt. The mechanism may be provided as a separate tensioning device or be integrated into the overall form of the child safety seat.

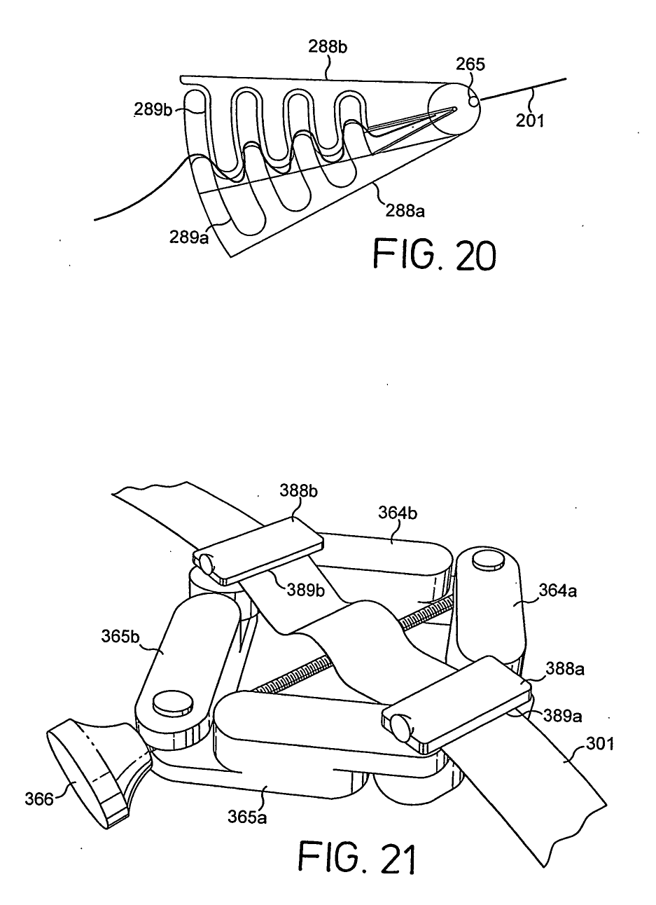

A second alternative seat belt tensioning system is shown in FIG. 21. The system comprises a ‘car jack’ arrangement for providing seat belt tension. Spaced belt-clamping elements 388a, 388b are provided with belt-shaped clamping slots 389a, 389b, each for receipt and clamping of part of the belt 301 to be tensioned. A first pair 364a, 365a of tensioning arms leads off from the first belt-clamping element 388a and a second pair of tensioning arms 364b, 365b leads off from the second belt-clamping element 388b. The opposing ends of the tensioning arms 364a-b, 365a-b are then articulated as shown such that an overall ‘extendible diamond’ shape is created. Screw tensioner 366 provides control over the extension/compression of the diamond shape. It will be appreciated that when the belt 301 is clamped at the clamping points 389a, 389b any compression of the diamond, responsive to the screw tensioner 366, that decreases the distance between the clamping points 389a, 389b will also tension the belt.

The ‘car jack’ mechanism of FIG. 21 may also be located to introduce tension at any point in the vehicle belt, and be employed for either the shoulder or lap vehicle belt. The mechanism may be provided as a separate tensioning device or be integrated into the overall form of the child safety seat.

It will be understood that the present disclosure is for the purpose of illustration only and the invention extends to modifications, variations and improvements thereto.

The application of which this description and claims form part may be used as a basis for priority in respect of any subsequent application. The claims of such subsequent application may be directed to any feature or combination of features described therein. They may take the form of product, method or use claims and may include, by way of example and without limitation, one or more of the following claims:

1. A child safety seat for use with a vehicle seat comprising a cradle arranged for secure fitting to said vehicle seat, said cradle having a base part and an upright support part; a turntable, rotationally mounting to said base part of said cradle; and a seat shell, mounting on said turntable such that the turntable and said seat shell are rotatable in tandem relative to the cradle, wherein said turntable also rotationally mounts to said upright support part of the cradle.

2. A child safety seat according to claim 1, wherein the base part and upright support part of the cradle form an assembly of separate parts.

3. A child safety seat according to claim 1, wherein the base part and upright support part of the cradle are in the form an integral cradle.

4. A child safety seat according to claim 1, wherein the base part of the cradle is provided with a cut-away portion for ready receipt of the turntable.

5. A child safety seat according to claim 1, wherein the rotational mounting of the turntable to the cradle is by means of a spindle.

6. A child safety seat according to claim 1, wherein the seat shell has the form of a ‘sit up’ seat.

7. A child safety seat according to claim 1, wherein the seat shell has the form of an infant carrier.

8. A child safety seat according to claim 1, wherein the seat shell mounts to the turntable for ready mounting and demounting.

9. A child safety seat according to claim 8, wherein the turntable is arranged for interchangeable mounting of seat shells in ‘sit up’ seat and infant carrier forms.

10. A child safety seat according to claim 1, wherein the turntable comprises an upright part arranged for rotational mounting to the upright support part of the cradle.

11. A child safety seat according to claim 1, wherein the turntable rotationally mounts to the upright support part of the cradle by means of a track and rail mounting.

12. A child safety seat according to claim 11, wherein a track is provided to said upright part of the turntable, the upright part of the cradle or to both; and a rail is provided to said track or tracks, thereby forming said track and rail mounting.

13. A child safety seat according to claim 11, wherein the track and rail mounting has curved form.

14. A child safety seat according to claim 11, wherein the rail defines an ‘H form’ profile and the track is provided with ledges for receipt of the legs of said ‘H form’ rail.

15. A child safety seat according to claim 1, wherein a base of the seat shell remains in close relationship to base part of the cradle during rotation of the seat shell.

16. A child safety seat according to claim 1, wherein one or more rollers are provided to the rotationally relating parts of either the cradle or turntable or both such as to provide rolling engagement there between.

17. A child safety seat according to claim 16, wherein said one or more rollers comprise or are coated with a friction-reducing material.

18. A child safety seat according to claim 1, wherein a reclining mechanism is provided to the turntable and/or the child safety seat shell and acts as a coupling therebetween.

19. A child safety seat according to claim 18, wherein the reclining mechanism is arranged such that when the turntable is rotated relative to the cradle, both the recline mechanism and seat shell rotate in tandem therewith.

20. A child safety seat according to claim 1, wherein a rotational lock is provided to prevent unintended rotation of the turntable relative to the cradle.

21. A child safety seat according to claim 1, wherein a unidirectional lock is provided to allow rotation of the turntable relative to the cradle in one rotational direction only.

22. A child safety seat according to claim 1, wherein the base part of the cradle is provided with one or more ISOFIX fittings.

23. A child safety seat according to claim 1, wherein the cradle is provided with a vehicle shoulder belt fitting for receipt of a vehicle shoulder belt and two vehicle lap belt fittings for receipt of a vehicle lap belt.

24. child safety seat according to claim 23, wherein the vehicle shoulder belt fitting locates centrally on the upright support part of the cradle.

25. A child safety seat according to claim 23, wherein the vehicle shoulder belt fitting is provided with a lock-off element that allows for ready passage of the vehicle shoulder belt in one direction only.

26. A child safety seat according to claim 23, wherein said vehicle lap belt fittings are provided at the base part of the cradle.

27. A child safety seat according to claim 1, wherein the cradle is provided with a seat belt tensioning means for tensioning a vehicle belt.

28. A child safety seat according to claim 27, wherein said seat belt tensioning means acts such as to alter the effective path of travel of the belt, thereby introducing tension.

29. A child safety seat according to claim 27, wherein the seat belt tensioning means comprises a drum provided with a slot for receipt of a vehicle seat belt; and a drum spindle, for rotationally mounting the drum to the cradle.

30. A child safety seat according to claim 29, wherein the cradle is further provided with rotational force means for transferring rotational force to the drum.

31. A child safety seat according to claim 30, wherein said rotational force means comprises an articulated system including one or more levers or pivots.

32. A child safety seat according to claim 27, wherein the seat belt tensioning means comprises a pair of jaws provided with contoured or toothed surfaces and hinged together by a hinge element, said hinged element including a belt-shaped slot for receipt of the vehicle seat belt.

33. A child safety seat shell and turntable assembly for use with a cradle arranged for secure fitting to a vehicle seat, said cradle having a base part and an upright support part, to form a child safety seat according to claim 1, the assembly comprising a turntable, rotationally mountable to said base part of said cradle; and a seat shell, mounting to said turntable such that the turntable and said seat shell are rotatable in tandem relative to the cradle, wherein said turntable is also rotationally mountable to said upright support part of the cradle.

34. A cradle assembly arranged for use with the child safety seat and turntable assembly of claim 33, the cradle assembly comprising a cradle arranged for secure fitting to said vehicle seat, said cradle having a base part and an upright support part; said base part of said cradle arranged for rotational mounting of a turntable, wherein said upright support part of the cradle is also arranged for rotational mounting of said turntable.

35. A cradle and turntable assembly for use with a seat shell to form a child safety seat according to claim 1, said cradle and turntable assembly comprising a cradle arranged for secure fitting to said vehicle seat, said cradle having a base part and an upright support part;
a turntable, rotationally mounting to said base part of said cradle, and arranged for rotational mounting of said seat shell such that said turntable and the seat shell are rotatable in tandem relative to the cradle, wherein said turntable also rotationally mounts to said upright support part of the cradle.

36. A vehicle seat assembly comprising a vehicle seat; and a child safety seat according to claim 1 fitting to said vehicle seat.
